(19) United States
(12) Patent Application Publication
(10) Pub. No.: US 2015/0040834 A1
(43) Pub. Date: Feb. 12, 2015

(54) SELF-CLOSING STALL FOR AN ANIMAL

(71) Applicant: Canarm Ltd., Brockville (CA)

(72) Inventors: Kevin Loos, Clifford (CA); Dan Martin, Elmira (CA)

(73) Assignee: Canarm Ltd., Brockville (CA)

(21) Appl. No.: 14/453,363

(22) Filed: Aug. 6, 2014

Related U.S. Application Data
(60) Provisional application No. 61/862,665, filed on Aug. 6, 2013.

(51) Int. Cl. A01K 1/02; A01K 5/02

(52) U.S. Cl. CPC A01K 1/0209; A01K 5/0275; A01K 5/0225
USPC 119/518; 119/524

(57) ABSTRACT

A feeding stall for an animal that allows a gestating sow or other animal to enter the stall for feeding, in which movement of the sow triggers automatic closure of a gate assembly, without manual intervention from the farmer. This protects the sow from other sows when it is feeding. When the sow has finished feeding, it can readily exit the stall, opening the entrance gate without manual intervention. Opening and closing of the gate is actuated when the sow urges the gate assembly open or closed. The sow need provide only an initial impulse against the gate, with the remainder of the rotation being provided by a biasing member which urges the gate into the fully open or closed position after being tilted past a neutral position.

### FIELD OF THE INVENTION

The present invention relates to agricultural equipment for animal husbandry, in particular a feeding stall which has particular application for gestating sows in group pen environments.

### BACKGROUND

Gestation stalls are used in swine husbandry as means to protect sows from each other when feeding. Fighting amongst sows and “bullying” by a dominant sow are common behaviour patterns. Stalls for isolating animals are also useful for other agricultural and animal husbandry applications. It is preferable to isolate sows when feeding while leaving them free to mingle with other sows at other times in a group pen.

A typical gestation stall is an enclosure with an entrance gate at one end for a sow or other animal to enter to feed from a feeding trough located at the opposed end. The entrance gate may be connected to the stall body via an arrangement of linkages that are spring loaded to keep the gate open and which closes after a sow enters the stall. After the sow has eaten, the gate can reopened for the sow to exit. The sow (or other animal) is typically unable to actuate the gate by itself to enter and exit on demand. Instead, manual operation of the gate by an operator may be required to open and close the gate. This type of system is not practical where the stall is located within a group pen and the feeding stall is frequently accessed by sows as they utilize the stall for feeding. As well, the complexity of existing systems can result in jamming and breakdown.

### SUMMARY OF THE INVENTION

The present invention relates to a stall for an animal in which the gate may be actuated by the animal without the need for human intervention, which has particular application for isolating gestating sows for individual feeding within a group pen environment. The gate is associated with a gate assembly which can be opened or closed from the interior of the stall by the animal contacting a component of the stall which when contacted actuates the gate to open or close, using the force applied by the animal to actuate the gate. The stall includes a gate assembly which is retained in either of the open or closed position but to either admit an animal or isolate an animal within stall, and which can then be displaced between these positions by an animal located within the stall but not by an animal located outside the stall.

According to one aspect, the invention relates to a stall for an animal comprising an enclosure having a rearward end defined by an opening for the animal, an opposed forward end and a gate assembly. The gate assembly comprises in a broad aspect a gate portion moveable between open and closed positions for selectively blocking said open end, a lever member connected to the gate for urging the gate closed when contacted by an animal entering the enclosure and a biasing member connected to said lever member for urging the gate assembly into the open or closed positions. The biasing member is configured to urge the gate assembly towards the closed position when the gate assembly is provided with an initial impulse towards the closed position past a neutral balanced position and to urge the gate towards the open position when the gate assembly is provided with an initial impulse towards the open position past the neutral position.

The biasing member may comprise a fixed member engaged to the gate assembly and a moveable component that is displaceable along said fixed member. In this aspect, tilting of the biasing member forwardly past the neutral position displaces the moveable component forwardly wherein gravity acts on the biasing member to urge the gate open and tilting of said biasing member rearwardly past the neutral position displaces the moveable component rearwardly wherein gravity acts on the biasing member to urge the gate closed.

The fixed member may consist of a container having opposed ends such that the moveable component is enclosed within said container. The moveable component may consist of a flowable substance such as water or other liquid-containing substance.

The fixed member of the biasing member may span a balance point of said gate assembly, which can be defined by a pivot mount that secures the lever member to the enclosure. The fixed member may incline downwardly and rearwardly when said gate is closed, for example at an angle of about 10 to 15° from the horizontal. The lever member may be configured to decline downwardly into the interior of said stall when the gate is open for contact with said animal upon entering said stall and to rotate upwardly to form a top of said stall when said gate is closed.

According to another aspect the stall includes a first latch to latch said gate in the closed position. The latch comprises a latch body rotatable between a latched position for engaging the enclosure and an unlatched position wherein the latch body is configured for contact with the animal within the enclosure for unlatching upon contact with an animal from the interior of said enclosure. The latch body may comprise an arm rotatably engaged to said gate assembly having an upper end for contacting said enclosure. According to this aspect, rotation of said arm in a first direction engages said arm with the enclosure to latch said gate assembly in a closed position and the arm is configured for contact with an animal within said enclosure during exit therefrom whereby such contact rotates the arm into a disengagement position to unlatch said gate assembly.

The stall may further include a second latch for securing the gate assembly in a closed position. The second latch may comprise a latch keeper on the exterior of the stall for actuation of the latch by an operator from the exterior of the stall. The second latch may further include a latch body moveable by said latch keeper between a first position configured to engage said gate assembly upon closure of said gate and a second position wherein said latch body is disengaged from said gate assembly.

According to a further aspect, the stall may further include a feed dispensing assembly comprising a hopper, a feed metering unit and a discharge chute. The feed metering unit may be configured to release a selected quantity and/or mixture of feed from said hopper to said chute in response to an electronic signal from a central electronic processing unit (CPU).

According to a further aspect, the invention relates to a gate assembly for an animal feeding stall which comprises an enclosure having a rearward end defined by an opening for the animal, an opposed forward end. The gate assembly comprises a gate moveable between open and closed positions for selectively blocking said open end, a lever member connected to the gate for urging the gate closed when contacted by an animal entering the enclosure and a biasing member connected to said lever member for urging the gate assembly into the open or closed positions. The biasing member is configured to urge the gate assembly towards the closed position when the gate assembly is provided with an initial impulse towards the closed position past a neutral balanced position and to urge the gate towards the open position when the gate assembly is provided with an initial impulse towards the open position past the neutral position.

The biasing member and lever member of the gate assembly may optionally be as recited above.

The gate assembly may be further comprise a pivot mount for mounting the gate assembly to the enclosure and pivoting the gate assembly about a horizontal axis whereby the horizontal axis defines a balance point of said gate and the lever member extends forwardly of said pivot mount and angles downwardly into said stall when closed.

According to the present invention, during normal operation the gate may be automatically mechanically closed by an animal entering the enclosure and exerting a force against a lever member within the enclosure (which is positioned to obstruct the animal's normal movemento) and subsequently opened by the animal from within the enclosure without any manual intervention by the farmer, solely by forces exerted by the animal during its normal movement into and out of the stall. In addition, because of its simplicity, this invention requires less maintenance than at least some other stall systems known to the art, thus reducing the overall maintenance cost of a barn.

Further aspects of the invention are explained with the aid of drawings and a detailed description which describe certain non-limiting embodiments of the invention.

### BRIEF DESCRIPTION OF THE DRAWINGS

FIG. 1 is a perspective view of a stall with the gate in a closed position according to a first embodiment of invention.

FIG. 2 is a perspective view as in FIG. 1 showing the gate in the open position.

FIG. 3 is an exploded perspective view of the first embodiment, in the closed position, seen from the rear thereof.

FIG. 4 is an enlarged perspective view of a portion of the stall, indicated by “A” in FIG. 3

FIG. 5 is an exploded perspective view of the first embodiment in the closed position, from the front thereof.

FIG. 6 is an enlarged perspective view of the portion shown in “B” of FIG. 5.

FIG. 7 is a further perspective view of the first embodiment showing an optional anti lie-down bar and feeder assembly.

FIG. 8 is a front elevational view thereof.

FIG. 9 is a top view thereof.

FIG. 10 is a side view thereof.

FIGS. 11 and 12 are schematic views, in side elevation, of the gate assembly in the open and closed positions respectively.

FIG. 13 is a perspective view showing the second latch assembly of the stall, in the latch engagement position.

FIG. 14 is a further perspective view showing the second latch assembly, in the latch disengagement position.

FIG. 15 is a further perspective view showing an enlarged view of a portion of the second latch assembly, showing the latch in an engagement position.

FIG. 16 is a perspective view showing an enlarged view of the second latch assembly in the latch engagement position.

FIG. 17 is a perspective view of a second embodiment wherein the feeder comprises dual feed hoppers.

FIG. 18 is a perspective view of a fourth embodiment of the invention comprising quadruple stalls.

FIG. 19 is a perspective view of a third embodiment of the invention comprising dual stalls.

### DETAILED DESCRIPTION

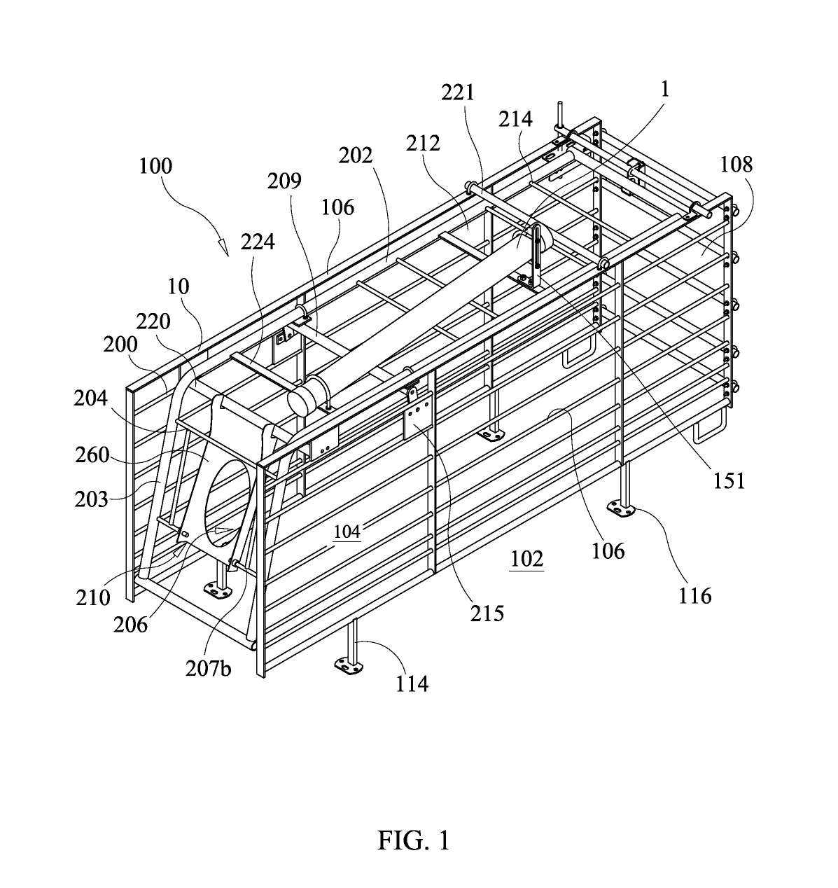

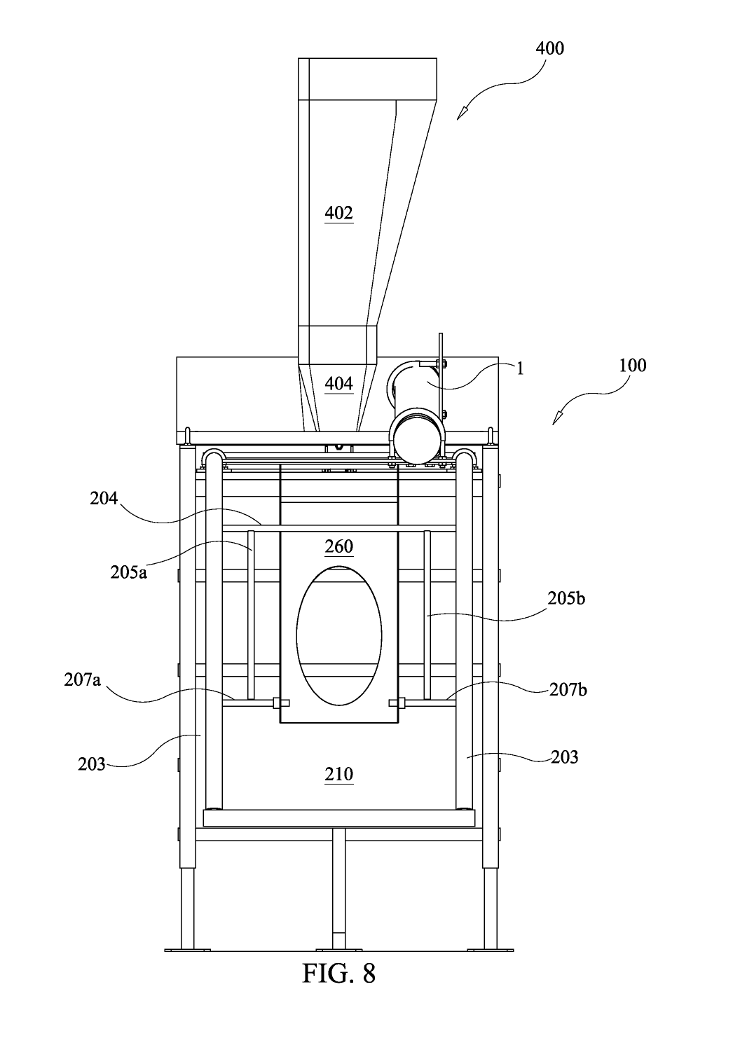

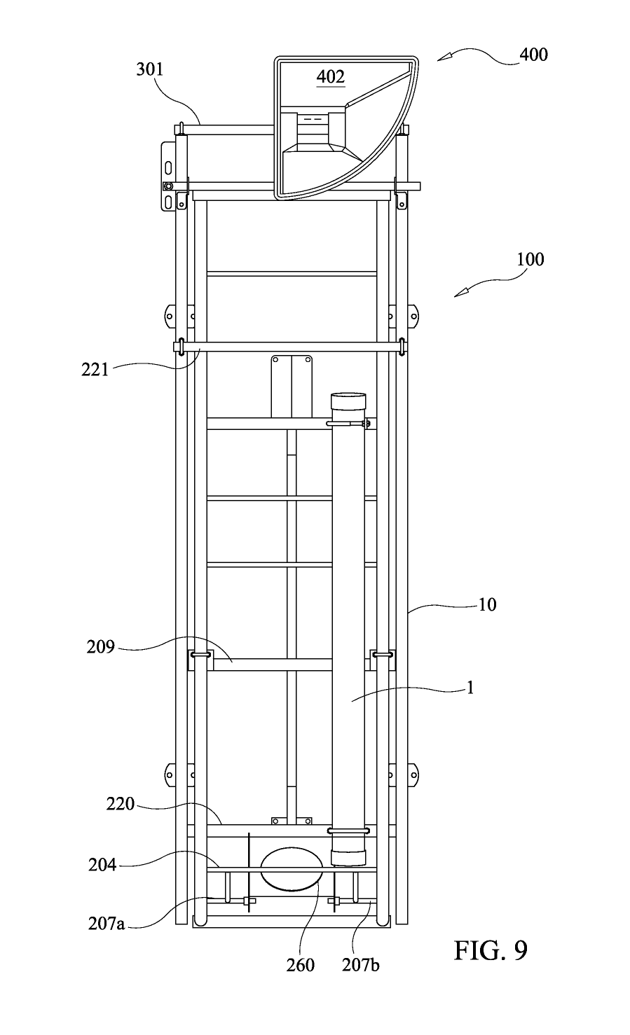

Referring initially to FIGS. 1-10, a feeding stall 100 according to the invention is shown. Feeding stall 100 can be used for feeding hogs, in particular gestating sows, to permit the animals to feed undisturbed by other animals. Stall 100 has particular application in a group pen environment in which it is desirable to isolate sows during feeding. As well, it will be seen that the invention may be adapted for use by other animals. Feeding stall 100 is intended for use in a facility such as a barn having a generally flat floor 102. Stall 100 comprises an open-framed enclosure 10 defined by opposing vertical sidewalls 104 composed of metal bars 106, a front end wall 108, a substantially open top 112 and an open rear end 115 for animal entry/exit. Rear end 115 is selectively blocked by a gate 200 as described below which is rotatably engaged to the enclosure 10. Top 112 is closable by a gate assembly 200, described below.

The spacing of bars 106 of sidewalls 104 may vary depending on the expected animal size and other factors that may dictate the need for smaller or larger spacing. The bottom of stall 100 can be open to floor 102. Frame 100 is supported by legs 114 which rest on feet 116 that may optionally be bolted or otherwise fastened to floor 102. The various frame members that make up enclosure 10 may be fabricated from steel rods, bars and/or plates, or other suitable frame members that can be fabricated into enclosure 100 by being welded, bolted or otherwise fastened together to form a rigid and robust structure consisting of a generally open framework

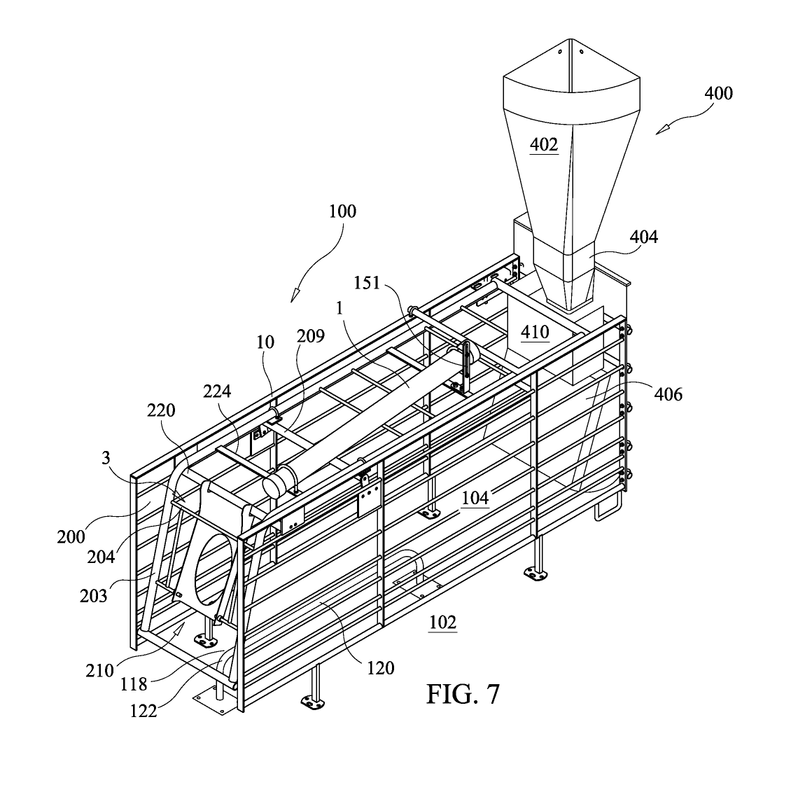

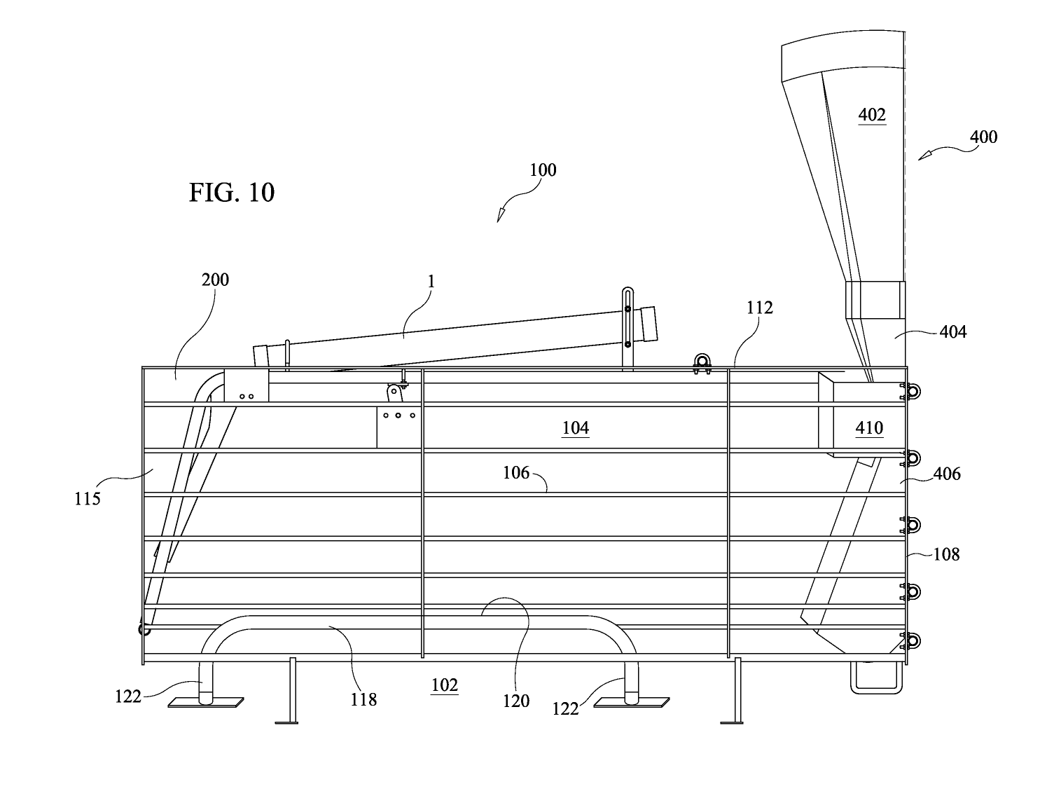

A sow anti-lie down bar 118, shown in FIGS. 7 and 10, may be installed within stall 100 to prevent sows from lying down within the stall, thereby expediting the feeding process. Bar 118 comprises a horizontal member 120 elevated from the ground by legs 122, which may be bolted to the floor. Bar 118 may optionally be secured to a sidewall 104 of stall 100.

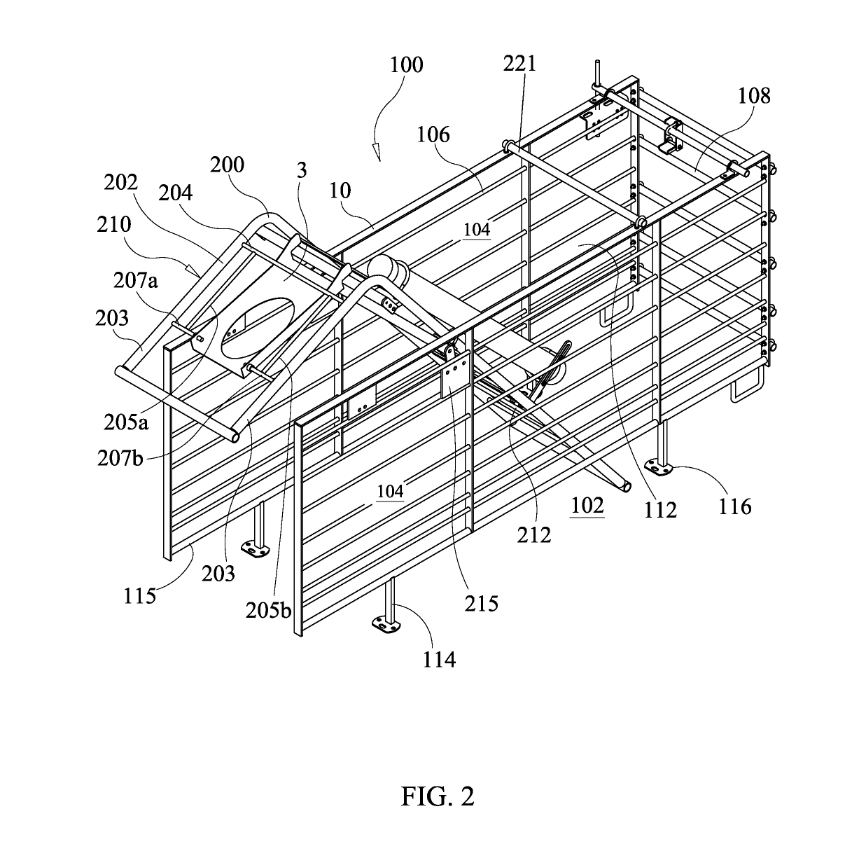

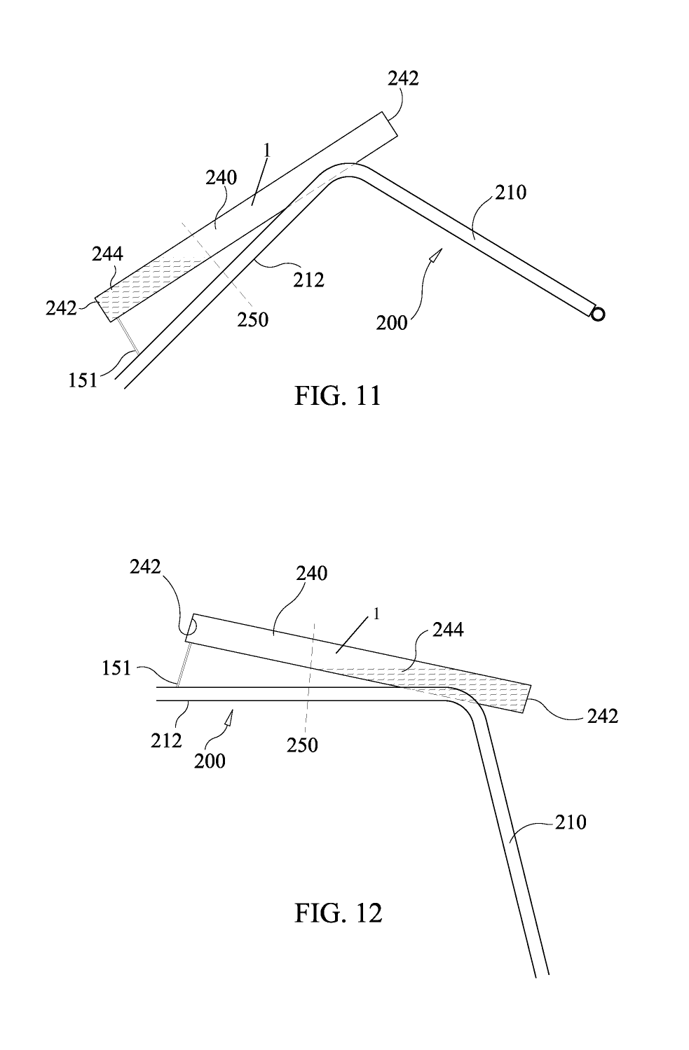

Stall 100 further comprises a gate assembly 200, shown in isolation in FIGS. 11 and 12, which is operable by a sow to isolate itself within the stall. Gate assembly 200 comprises parallel, spaced apart frame members 202 which are generally L-shaped. Gate assembly 200 can pivot upwardly upon actuation by a sow from within the enclosure to open the gate or downwardly to close the gate. A first end of frame members angles downwardly and forms a gate 210 opposed to end wall 108. Gate 210 is defined by downwardly-angled segments 203 of frame members 202, an upper cross bar 204 which spans segments 203, a pair of lower cross bars 207a and 207b which extend horizontally towards each from a lower portion of segments 203, a pair of spaced apart vertical bars 205a and 205b which extend between respective lower cross bars 206 and upper cross bar 204 and a pivoting latch actuator panel 260. Panel 260 has a central oval opening 206 which is configured for performing procedures on sows as they feed. Frame members 202 also include a generally horizontal (when the gate is closed) segment that merges with gate 210 and which defines a lever member 212. Gate assembly 200 is pivotally mounted to sidewalls 104 at lever member 212. Lever member 212 is further defined by an array of cross bars 214 that span frame members 202. Lever member 212 covers the top of stall 100 when gate assembly 200 is closed, as seen in FIG. 1. The open position of gate assembly 200 is shown in FIG. 2 and in this position, lever member 212 is inclined downwardly and forwardly to a position that fully or partially blocks the interior of stall 100 to block access of the sow to the feed located on the other side of lever member 212. As described below, in order to reach the feed, the sow is required to contact lever member 212 as she moves towards the feed and thereby urges it upwardly out of the way. This action causes lever member 212 to rotate upwardly, thereby lowering gate 210 and closing the stall.

Gate 210 is angled rearwardly and downwardly when closed. As a result of the rearward slope, when the sow within stall 100 backs away from the feeding area (for example, when the sow has finished feeding and wishes to exit stall 100), rearward pressure exerted against gate 210 is translated into a vertical force acting on gate assembly 210 which causes gate assembly 200 to rotate upwardly. As described below, this initiates opening of the gate to allow the sow to depart, which also lowers lever member 212 for the next sow to contact upon entry into stall 100.

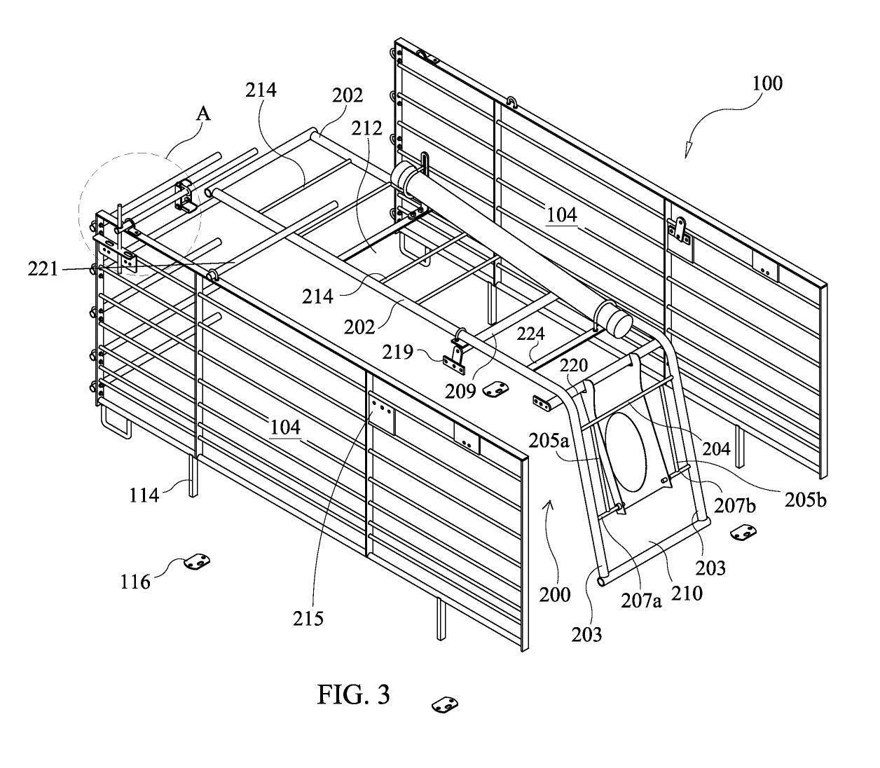

Gate assembly 200 is hinged to sidewalls 104 by a pivot bar 209 that spans and extends past frame members 202. Pivot bar 209, seen in detail in the exploded views shown in FIGS. 3 and 5, comprises a transverse member fastened to frame members 202 that defines a horizontal axis of rotation of gate assembly 200. The respective ends of pivot bar 209 are attached to downwardly-extending arms 214, which in turn are each pivotally mounted to a corresponding sidewall 104 by a mount plate 215 by pivot bolts, bushings or other pivotal attachment means.

Pivot bar 207 is located relative to gate assembly 200 at or close to the center of gravity or balance point 250 of gate assembly 200. As a result, gate assembly 200 is balanced on pivot bar 207 and minimal effort is required to rotate gate assembly 200 in either direction about pivot bar 207. Gate assembly 200 is rotatable between the closed position of FIG. 1 and the open position of FIG. 2. The open position seen in FIG. 2 is defined by contact of the forward end of lever member 212 with the ground. The closed position seen in FIG. 2 is defined by contact between lever member 212 and a transverse bar 120 extending between sidewalls 104 adjacent to open rear end 115. In this position, gate assembly 200 rests on bar 120. In the closed position of FIG. 1, gate 210 blocks the opening 115 of stall 100. When rotated into the open position of FIG. 2, gate 210 is clear of opening 115 of stall 100 to permit entry or exit of an animal. In this position, lever member 212 angles downwardly into the interior of stall 100 where it may be contacted by an animal entering stall 100 as described below.

Rotation of gate assembly 200 is facilitated by a biasing member 1 mounted to gate assembly 200, seen in detail in FIGS. 11 and 12. Biasing member 1 urges gate assembly 200 towards the closed position when the gate is tilted past the balanced or neutral position towards the closed position and also urges gate assembly 200 towards the open position when the gate is tilted past the balance position towards the open position. When gate assembly 200 is precisely at its balance or neutral position, biasing member does not exert a force in either rotational direction on gate assembly 200. In the present embodiment, biasing member 1 achieves this result by shifting its center of gravity as it is tilted in one direction or the other. This is accomplished by providing an elongate member with a moveable center of gravity wherein when biasing member is horizontal it is in a neutral, balanced position and when tilted in one direction or the other along a horizontal axis which is transverse to the elongate (front to rear) axis of stall 100, it applies a downward force towards one end or the other. In the present embodiment, biasing member 1 comprises a hollow plastic tube 240 having sealed ends 242 within which a free-flowing substance 244 such as water or other fluid or sand is retained to shift its center of gravity as the biasing member is tilted. It will be seen that any substance or article may be incorporated into the biasing member that can move from one end of the member to the other, such as any flowable substance trapped within tube 240. Biasing member 1 may comprise in general terms a combination of a fixed member and a moveable component that can travel along the fixed member towards respective forward and rearward ends thereof to shift the center of gravity sufficiently to overcome anti-rotational forces acting on gate assembly 200, such as frictional forces, inertia, slight shifts in weight brought on by accumulation of debris and others. The moveable component may comprise any object(s) or substance that can be displaced along the fixed member by tilting thereof along a horizontal transverse axis.

Biasing member 1 is mounted to gate assembly 200 at an angle whereby when lever member 212 is horizontal, biasing member 1 declines downwardly and rearwardly. For this purpose, biasing member 1 is connected at its rearward end directly to crossbar 204 of lever member 212 adjacent to gate 210. The forward end of biasing member 1 is connected to lever member 212 via a post 151 which elevates the forward end thereof relative to its rearward end. Biasing member 1 thus inclines downwardly towards the rear of stall 100 when the gate assembly 200 is closed, for example by an angle of between 10 and 15°.

Biasing member 1 is centered over balance point 250 of the gate assembly 200 whereby biasing member may apply a substantially similar downward force acting in either direction of rotation of gate assembly 200, as the center of gravity of biasing member 1 is shifted forwardly or rearwardly of balance point 250. Due to the downward tilt of biasing member 1 when lever member 212 is horizontal, biasing member 1 exerts a downward force rearwardly of balance point 250 when gate assembly 200 is closed, thereby urging it towards the closed position. When gate assembly is rotated towards the open position, for example when a sow exerts a rearward force on gate 210, as soon as biasing member is rotated past the horizontal (balanced) position, it will start to exert a downward force on gate assembly 200 forwardly of balance point 250 thereby urging the gate towards the open position. It will thus be seen that a relatively slight nudge of the gate towards the open position, sufficient to elevate the gate past the balanced position of biasing member 1, will cause biasing member to urge the gate into the fully open position. The reverse sequence will occur on closing of the gate, when a sow enters into stall 100 and contacts the downwardly-angled portion of lever arm 212 located within the stall, urging it upwardly past the neutral position.

Biasing member 1 provides an overcenter-type action to selectively urge gate assembly 200 into either one of the open or closed position when gate assembly 200 is given an initial impulse towards either position past the balance point 250, and to retain it in the open or closed position until a sufficient countervailing force is applied which urges gate assembly 200 past the balance point 250 in the opposing direction. In this fashion, biasing member 1 serves to swing the gate into either one of the fully open or fully closed position when given an initial nudge by an animal either entering or exiting the stall. This fully opens the gate out of the way of the animal after the initial nudge towards the open position and fully closes the gate automatically once the animal has given an initial nudge in this direction as it approaches its food. As well, biasing member 1 serves to retain the gate in one of the open or closed position by the weight of gravity acting on balancing member 1, as its center of gravity shifts rearwardly and forwardly respectively.

Biasing member 1 may be opened to permit the flowable material to be added or removed if required. Biasing member 1 is partially filled with water 244 (shown in dotted lines in FIGS. 10 and 11). The amount of water inside biasing member 1 is typically about ⅓ of the total volume of the tube, although it will be seen that this amount may vary.

At the start of the sow feeding cycle, gate 200 is in the open position of FIG. 2, in which lever member 212 slopes downwardly and forwardly wherein its front edge contacts floor 102 adjacent to front end wall 108. Gate assembly 200 is retained in the open position by biasing member 1; at this stage the center of gravity of biasing member 1 is located forwardly of balance point 250 of gate 200 urging gate assembly 210 towards the open position. Animal feed is normally deposited at the front of stall 100 adjacent end wall 108, for example in a feed trough or deposited on the floor. In most cases, the feed will be deposited after the sow has entered the stall and its identity is confirmed. The sow enters the stall and walks to its front end as result having learned to expect feed to be deposited at that location, which is forwardly of lever member 212 when this is in the open position. As a result, lever member 212 effectively blocks the animal from reaching the location where food is normally deposited. This encourages the animal to contact lever member 212 to push it aside in order to reach the food location. As the sow enters the stall and walks towards the feed location, its head, shoulder or other body part pushes forwardly against lever member 212 as the sow urges itself against lever member 212. This action urges lever member 212 upwardly as it rotates the gate assembly towards the “closed” position. As this occurs, the water within biasing member 1 flows rearwardly, thereby shifting its center of gravity rearwardly until it reaches the neutral position and then the “overcenter” position where its center of gravity is located rearwardly of balance point 250. At this point, gate assembly 200 will continue rotating due to the rearwardly-located center of gravity urging it closed, until it reaches the fully closed position of FIG. 1.

Once gate assembly 200 is closed, a first latch assembly 3, described below, will then automatically actuate to prevent other animals outside stall 100 from forcing their way in, until the sow located within the stall actuates the gate assembly from within to open the gate. As well, since gate 210 slopes downwardly and outwardly, it is difficult for an animal outside the stall to force it open, since any direct forward force from outside the stall will tend to force the gate towards the closed position. However, a rearward force from a sow located within the interior of stall 100 will tend to urge gate 210 upwardly to open the gate.

When an animal within stall 100 wishes to exit stall 100, it will normally back out of the stall. In doing so, the sow will contact gate 210. The rearward force of the sow against gate 210 is translated into an upward force acting on gate assembly 200 due to the rearward slope of gate 210. This urges gate assembly 200 towards the open position. The fluid in the biasing member 1 flows towards the front of stall 100 shifting the center of gravity of biasing member 1 forwardly past the neutral position, such that gate assembly 200 is urged into the fully open position by biasing member 1. After the sow has urged the gate past the neutral position, no further force by the sow is required to fully open gate assembly 200. Furthermore, it will be seen than no intervention beyond the movement of the animal is needed to open or close the gate.

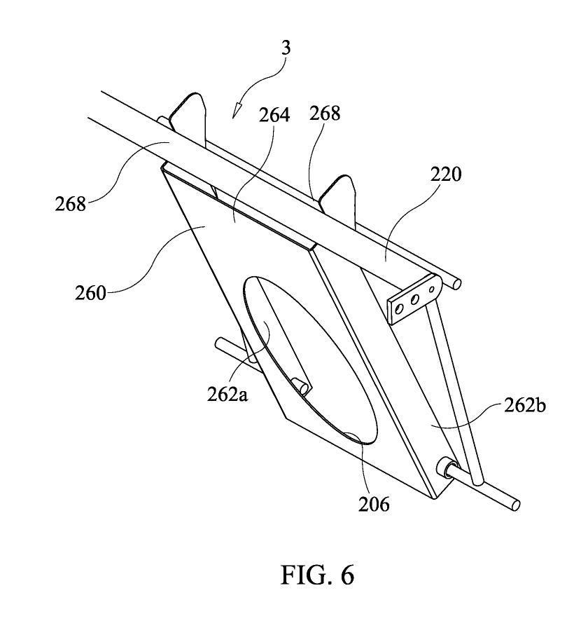

As seen in detail in FIG. 6, a first latch 3 may optionally be provided to secure gate 200 in the closed position. First latch 3 comprises a panel-shaped latch actuator 260 which is rotatably secured at its lower end to lower cross-bars 207a and b of gate 200, which are co-axially aligned. Actuator 260 comprises spaced apart sidewalls 262a and 262b spanned by a panel 264. Panel 264 has an oval opening 206 therein to provide access to the sow when the sow is facing away from gate 210 as she feeds for insemination or other procedures. Sidewalls 262a and b each have an opening for insertion therein of a corresponding one of cross-bars 207 whereby actuator 260 may rotate on co-axial bars 207a and b about a horizontal axis defined by the common axis of bars 207a and b. The upper ends of sidewalls 262a project upwardly of plate 264 and have cutaway regions 268. Cutaways 268 form cradles for contacting crossbar 120 that spans sidewalls 104 and which is fixedly mounted thereto. When gate assembly 200 is closed, latch 3 is engaged; this is actuated by the forward and upward tilt of gate 210 causing latch actuator 260 to rotate forwardly until cradles 268 engage crossbar 120 and rest against this member. When thus engaged, upward movement of gate assembly 200 is prevented by contact between the cradles 268 and enclosure crossbar 120. Latch 3 is disengaged by urging latch actuator 260 rearwardly, which can be actuated by a sow contacting actuator 260 as she moves rearwardly seeking to exit stall 100. This rotates actuator 260 rearwardly, disengaging cradles 268 from crossbar 120. At this point, latch 3 is disengaged and continued rearward force against actuator 260 causes gate assembly 200 to rotate upwardly into the open position.

As seen in FIG. 7, rotational movement of latch actuator 260 is confined in one direction by the upper gate crossbar 204 that spans frame members 202, and in a second direction by contact with cross bar 120. For this purpose, the respective bars 204 and 120 are spaced apart horizontally by a spacing that is sufficient to permit actuator 260 to travel in an arc that allows engagement and disengagement between cradles 268 and bar 120. Latch actuator can freely rotate in an arc defined by the horizontal space between these respective cross members.

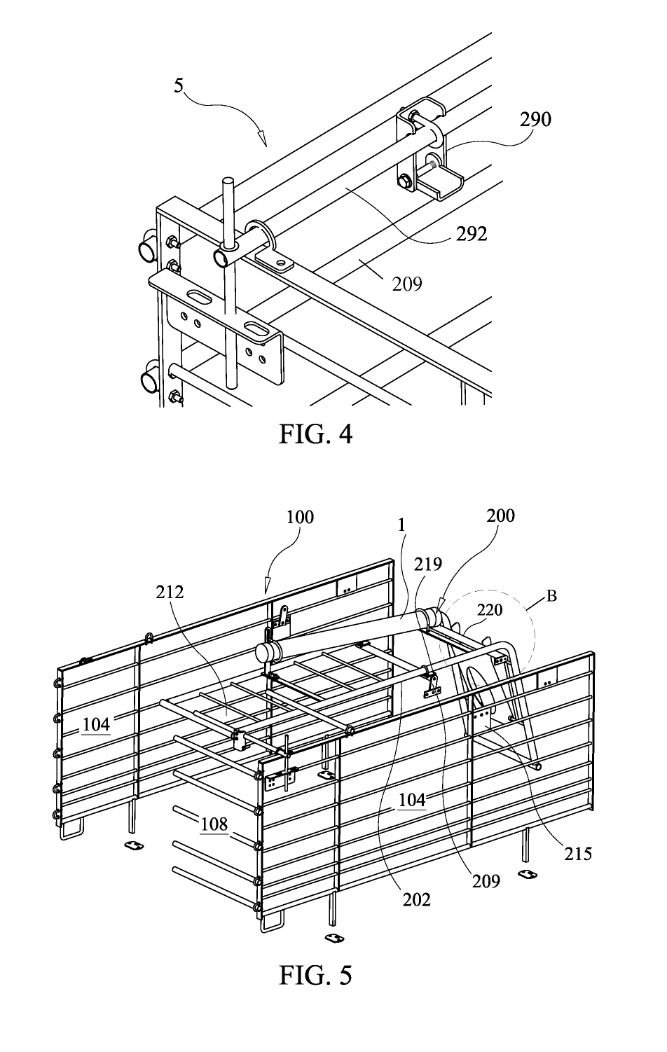

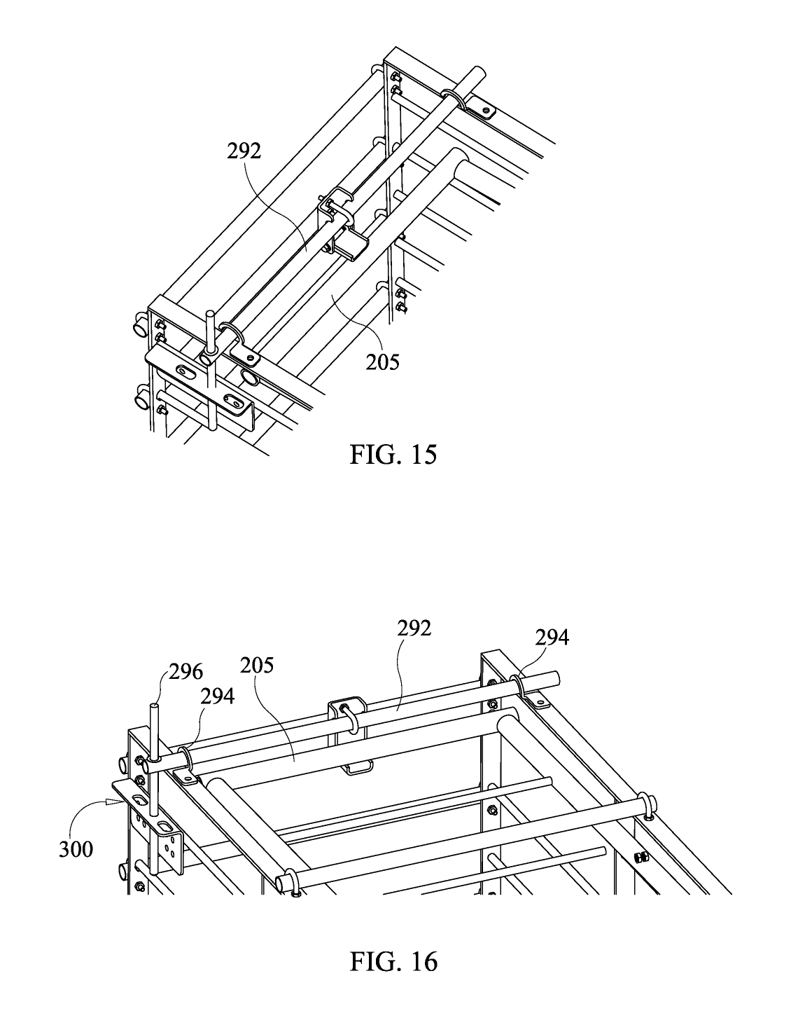

Stall 100 is provided with a second latch 5, seen in FIGS. 4 and 13-16, which is configured to secure stall 100 in a closed position. Latch 5 is operable solely from the outside of stall 100 to permit a farmer to secure gate assembly 210 in a closed position that cannot be opened by an animal, for example to perform an examination or other procedure on a sow while confined with the stall. Latch 5 comprises a latch body 290 rigidly secured to a rotatable crossbar 292 whereby rotation of crossbar 292 causes latch body 290 to rotate. Crossbar 292 is rotatably engaged within hubs 294 mounted to opposing sides of stall 100, whereby latch body 290 rotates upon rotation of crossbar 292. A handle 296 is engaged to crossbar 292 and comprises a bar that may be slideably engaged within opening 298 that extends through crossbar 292 adjacent an end thereof. Handle 296 permits a user to apply torque to crossbar 292 to easily actuate latch 5. Handle 296 slides within opening 298 in crossbar 292 to permit handle 296 to selectively engage a latch retainer 300.

Retainer 300 comprises a plate 302 welded to the exterior of stall 100 and projecting horizontally outwardly therefrom. Plate 302 has first and second openings 304 and 306 configured to receive handle 296 therein, defining latch and unlatched positions respectively. First opening 304 is positioned to retain the handle in a closed (engagement) position wherein gate assembly 200 may be automatically latched when closed and second opening 306 is positioned to retain handle 296 in an open (disengaged) position wherein gate assembly 210 is maintained in an unlatched position. Handle 296 may be selectively inserted in one or the other of openings 304 and 306.

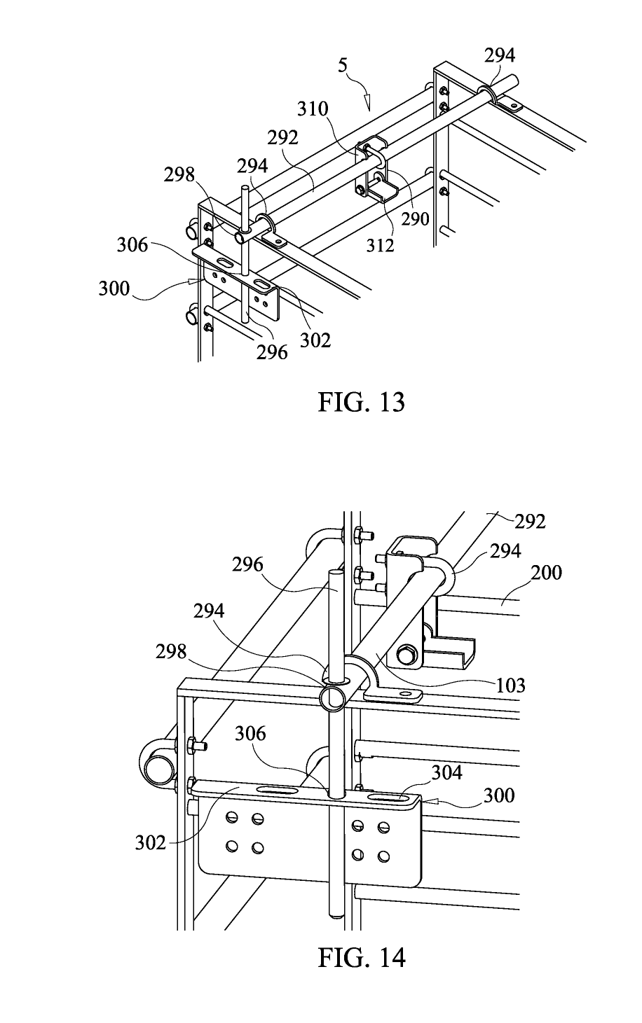

Latch body 290 comprises a base 310 which is fixedly mounted at a proximal end to crossbar 292 and a flipper 312 which is pivotally mounted to a distal end of base 310. Flipper 312 is configured to fold into base 310 wherein flipper 312 fits at least partially within the interior of base 310, and to unfold into an extended, engagement position as seen in FIG. 13 wherein flipper 312 is at a 90 degree angle to the elongate axis of base 310. Flipper 312 is prevented from rotating past 90 degrees by a stop member, not shown. Flipper 312 is configured to engage forward crossbar 205 of gate assembly 200 when unfolded, to prevent gate assembly 200 from downward movement.

In normal operation of stall 100, latch 5 is secured in an open position, as seen in FIG. 14. In this position, latch 5 is rotated out of engagement with crossbar 205 of gate assembly 200 into a non-engagement position where it is inoperative for engaging the gate assembly. Handle 296 is inserted within opening 306 to maintain latch 5 in the inoperative (disengaged) position. In this position, gate 200 may be freely opened and closed by an animal entering and exiting stall 100. If it is desired to secure gate 200 in a closed position, for example to hold an animal securely within stall or 100 or to prevent animals from entering stall 100, handle 296 is disengaged from opening 306 by sliding it out of engagement, and inserted into opening 304. This rotates latch 5 into the operative (engagement) position of FIGS. 13, 15 and 16. In this position, latch 5 can engage gate 200 when gate is closed. However, latch 5 remains of out engagement with gate 200 until gate 200 is closed, which permits the farmer to leave gate 200 open to receive an animal with latch 5 in the engagement position, wherein gate 200 automatically latches fixedly shut when an animal enters stall 100. At this time when gate 200 moves into the closed position, crossbar 205 contacts flipper 312 and pushes it upwardly thereby folding flipper 312 into base 310, to permit crossbar 205 to travel past flipper 312. Once out of contact with crossbar 205, flipper 312 unfolds by gravity and returns to the open position wherein it prevents downward travel of crossbar 205 and latches gate in a closed position until unlatched by rotation of handle 296.

Feeding stall 100 optionally comprises a feed dispenser 400. In the embodiment of FIGS. 7-10, feed dispenser 400 is an electronic sow feeding unit which comprises a hopper 402, a feed metering system 404 and a discharge chute 406. Discharge chute 406 deposits a metered quantity of feed on the ground for access by the sow. The mechanical components of metering system 404 are protected from the sow by a barrier 410. Metering system 404 is adapted to dispense a selected quantity of feed from hopper 402. Metering system 404 may comprise an electronic controller, not shown, which engages a feed dispenser to dispense a controlled quantity of feed in response to signals received from the central computer processing unit (“CPU”), not shown.

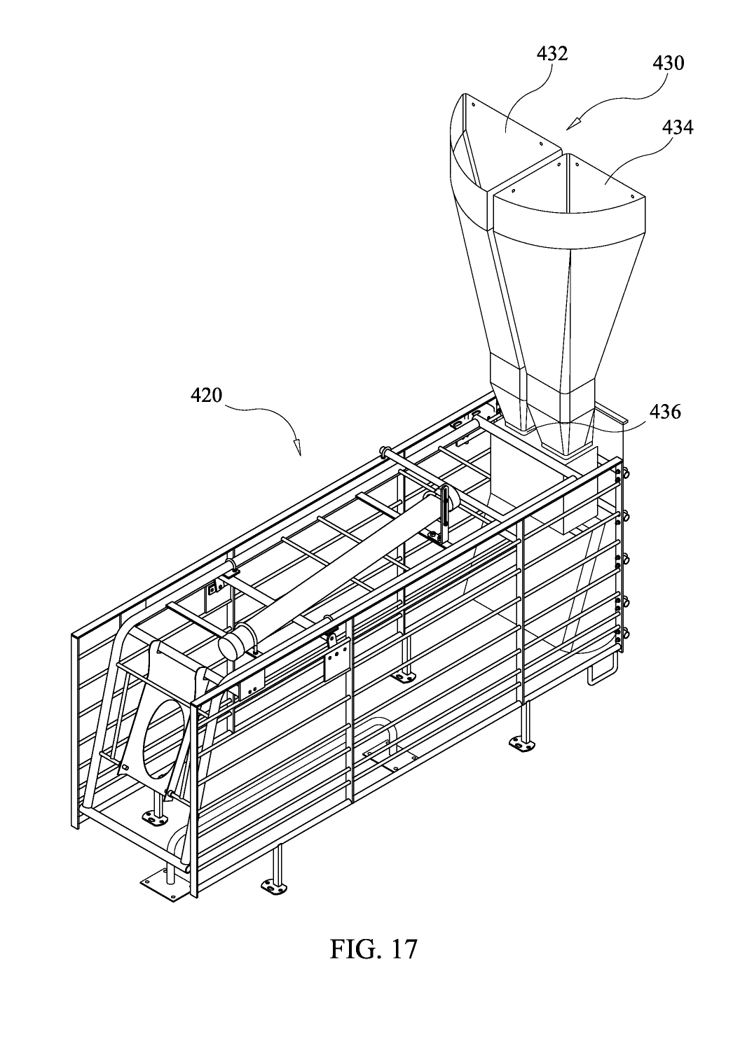

FIG. 17 shows a further embodiment of stall 420 wherein a feed dispenser 430 is provided which is similar to feed dispenser 400 but comprises dual hoppers 432 and 434 for separate feed ingredients that may be combined into a single feed stream for consumption by the sow. The ingredients may be combined in different ratios for different sows depending on predetermined criteria and data generated for each sow in the herd. Hoppers 432 and 434 feed into a dual feed metering system 436, which is similar to metering system 404 but is adapted to combine feed ingredients from dual hoppers 432 and 434.

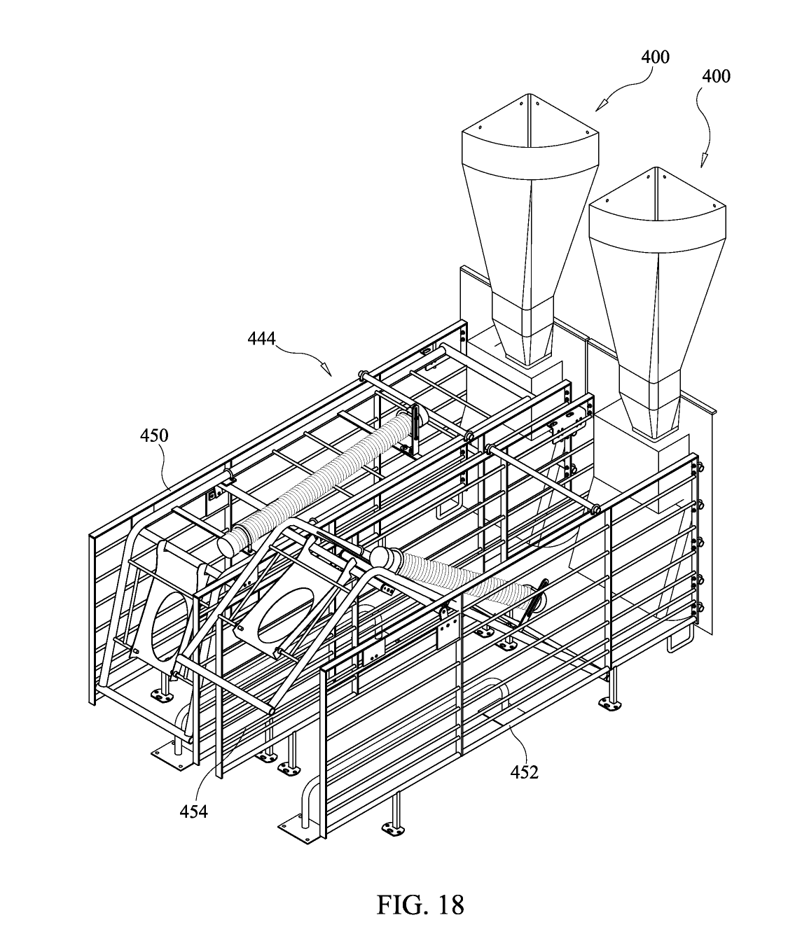

A further embodiment 449 is shown in FIG. 18 wherein dual feed stalls 450 and 452 are provided in side by side relation, each with a single hopper feed dispenser 400. It will be seen that one or both stalls may be provided a multi-hopper feed dispenser of the type described herein. Stalls 450 and 452 share a common sidewall 454 that divides the respective stalls.

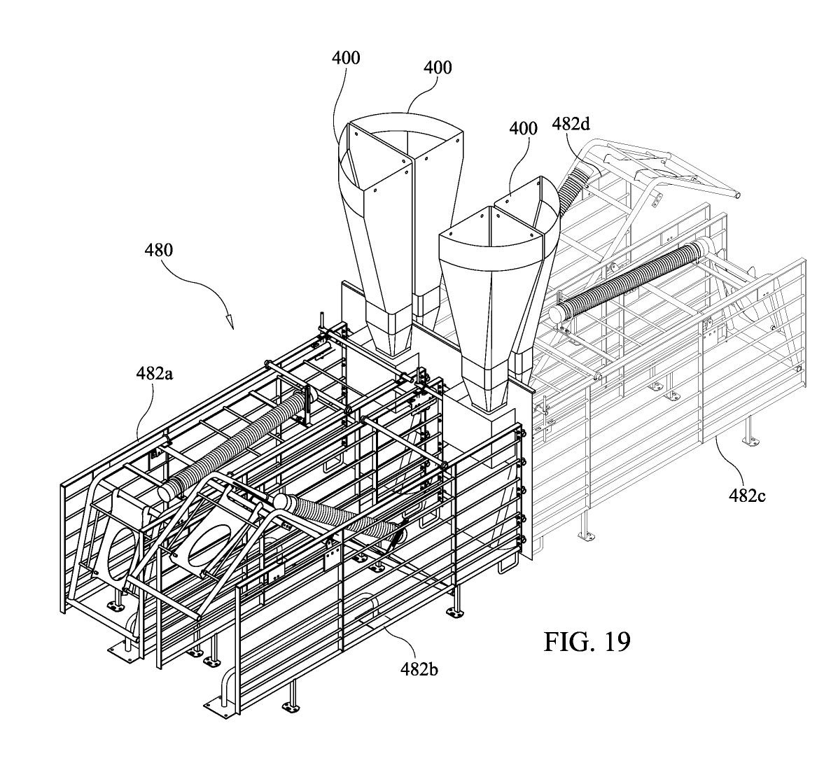

A further embodiment is shown in FIG. 19, which relates to a quadruple dispenser 480, comprising four feed stalls 482a, b, c and d. Stalls 482a and b and 482c and d are in respective side by side relation, and stalls 482a and b are in back-to-back relation to stalls 482c and d. Each of stalls 482a-d is provided with an independently controlled single hopper feed dispenser 400.

The CPU (not shown) maintains a database that can be updated in real time or on a delayed basis of the feed quantities and mixtures of feed and time of day of feed delivered to each sow in the herd by the present system.

It will be seen that feed dispensers 400 in the embodiments hereof may comprise any combination of single hoppers and multiple hoppers, depending on the application.

The present invention has been described herein by reference to particular embodiments. However, the scope of the invention should not be limited by the embodiments set forth in the examples, but should be given the broadest interpretation consistent with the description as a whole. The claims are not to be limited to the preferred or exemplified embodiments of the invention.

1) A stall for an animal comprising an enclosure having a rearward end defined by an opening for the animal, an opposed forward end and a gate assembly comprising a gate moveable between open and closed positions for selectively blocking said open end, a lever member connected to the gate for urging the gate closed when contacted by an animal entering the enclosure and a biasing member connected to said lever member for urging the gate assembly into the open or closed positions; wherein said biasing member is configured to urge the gate assembly towards the closed position when the gate assembly is provided with an initial impulse towards the closed position past a neutral balanced position and to urge the gate towards the open position when the gate assembly is provided with an initial impulse towards the open position past the neutral position.

2) The stall of claim 1 wherein said biasing member comprises a fixed member engaged to the gate assembly and a moveable component that is displaceable along said fixed member wherein tilting of said biasing member forwardly past the neutral position displaces the moveable component forwardly wherein gravity acts on the biasing member to urge the gate open and tilting of said biasing member rearwardly past the neutral position displaces the moveable component rearwardly wherein gravity acts on the biasing member to urge the gate closed.

3) The stall of claim 2 wherein said fixed member comprises a container having opposed ends and said moveable component is enclosed within said container.

4) The stall of claim 3 wherein said moveable component comprises a flowable substance.

5) The stall of claim 4 wherein said substance comprises a liquid.

6) The stall of claim 2 wherein said fixed member spans a balance point of said gate assembly.

7) The stall of claim 2 wherein said fixed member is inclined downwardly and rearwardly when said gate is closed.

8) The stall of claim 7 wherein the angle of said incline is about 10 to 15° from the horizontal.

9) The stall of claim 1 wherein a portion of said lever member is configured to decline downwardly into the interior of said stall when the gate is open for contact with said animal upon entering said stall and to rotate upwardly to form a top of said stall when said gate is closed.

10) The stall of claim 1 wherein said gate assembly further comprises a pivot mount for mounting the gate assembly to the enclosure and pivoting the gate assembly about a horizontal axis whereby the horizontal axis defines a balance point of said gate and the lever member extends forwardly of said pivot mount and angles downwardly into said stall when closed.

11) The stall of claim 1 further comprising a first latch to latch said gate in the closed position, said latch comprising latch body rotatable between a latched position for engaging the enclosure and an unlatched position wherein the latch body is configured for contact with the animal within the enclosure for unlatching upon contact with an animal from the interior of said enclosure.

12) The stall of claim 11 wherein said latch body comprises an arm rotatably engaged to said gate assembly having an upper end for contacting said enclosure, wherein rotation of said arm in a first direction engages said arm with the enclosure to latch said gate assembly in a closed position, said arm being configured for contact with an animal within said enclosure during exit therefrom whereby such contact rotates the arm into a disengagement position to unlatch said gate assembly.

13) The stall of claim 1 further comprising a second latch for securing the gate assembly in a closed position, said second latch comprising a latch keeper on the exterior of said stall for actuation of the latch by an operator from the exterior of the stall.

14) The stall of claim 13 wherein said second latch comprises a latch body moveable by said latch keeper between a first position configured to engage said gate assembly upon closure of said gate and a second position wherein said latch body is disengaged from said gate assembly.

15) The stall of claim 1, further comprising a feed dispensing assembly comprising a hopper, a feed metering unit and a discharge chute, wherein said feed metering unit is configured to release a selected quantity and/or mixture of feed from said hopper to said chute in response to an electronic signal from a central electronic processing unit (CPU).

16) A gate assembly for an animal feeding stall comprising an enclosure having a rearward end defined by an opening for the animal and an opposed forward end, wherein the gate assembly comprises a gate member moveable between open and closed positions for selectively blocking said open end, a lever member connected to the gate for urging the gate closed when contacted by an animal entering the enclosure and a biasing member connected to said lever member for urging the gate assembly into the open or closed positions; wherein said biasing member is configured to urge the gate assembly towards the closed position when the gate assembly is provided with an initial impulse towards the closed position past a neutral balanced position and to urge the gate towards the open position when the gate assembly is provided with an initial impulse towards the open position past the neutral position.

17) The gate assembly of claim 16 wherein said biasing member comprises a fixed member engaged to the gate assembly and a moveable component that is displaceable along said fixed member wherein tilting of said biasing member forwardly past the neutral position displaces the moveable component forwardly wherein gravity acts on the biasing member to urge the gate open and tilting of said biasing member rearwardly past the neutral position displaces the moveable component rearwardly wherein gravity acts on the biasing member to urge the gate closed.

18) The gate assembly of claim 17 wherein said fixed member comprises a container having opposed ends and said moveable component is enclosed within said container.

19) The gate assembly of claim 18 wherein said moveable component comprises a flowable substance.

20) The gate assembly of claim 19 wherein said substance comprises a liquid.

21) The gate assembly of claim 17 wherein said fixed member spans a balance point of said gate assembly.

22) The gate assembly of claim 17 wherein said fixed member is inclined downwardly and rearwardly when said gate is closed.

23) The gate assembly of claim 22 wherein the angle of said incline is about 10 to 15° from the horizontal.

24) The gate assembly of claim 16 wherein a portion of said lever member is configured to decline downwardly into the interior of said stall when the gate is open for contact with said animal upon entering said stall and to rotate upwardly to form a top of said stall when said gate is closed.

25) The gate assembly of claim 16 wherein said gate assembly further comprises a pivot mount for mounting the gate assembly to the enclosure and pivoting the gate assembly about a horizontal axis whereby the horizontal axis defines a balance point of said gate and the lever member extends forwardly of said pivot mount and angles downwardly into said stall when closed.
